(19) United States
(12) Patent Application Publication
(10) Pub. No.: US 2004/0168703 A1
(43) Pub. Date: Sep. 2, 2004

(54) Floss-pick

(76) Inventor: Myoung-Ho Cho, Seoul (KR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/474,543

(22) PCT Filed: Apr. 9, 2002
(86) PCT No.: PCT/KR02/00615

(30) Foreign Application Priority Data
Apr. 9, 2001 (KR) 2001/20305

(51) Int. Cl. A61C 15/00

(52) U.S. Cl. 132/323; 132/321

(57) ABSTRACT

A disposable dental hygiene implement comprises an elongated small pick member having a body portion (53) and a picking portion (55) and floss member (71) provided to the body portion and/or the picking portion. At the end of the picking portion said pick member has buffering structure comprised of marginal end (56) of the picking portion (55) and floss member (71) that are integrally intermingled to each other. Said floss member (71) further extends outwardly at the end of the picking portion (55), and a gripping member (81) is provided at the end of the floss member for the user to easily and firmly grasp the floss member (71) for efficient flossing operation.

### FIELD OF THE INVENTION

The present invention relates to a dental hygiene implement, and more particularly to a disposable dental floss-pick implement that comprises a tooth pick member having an elongated length and small diameter and a strand(s) of floss material provided to said tooth pick member.

### BACKGROUND OF THE INVENTION

The toothpicks are used to remove relatively large pieces of food that have become wedged between teeth, and the toothpicks are presently the only public disposable tooth cleaning device that has found wide social acceptability.

However, the critical drawback of conventional toothpicks is that the sharp and stiff needle pointed end of the toothpick hurts and damages the soft, tender and delicate gum tissue.

It is also well known that dental floss has the proper abrasive texture and flexibility to effectively remove dental plaque from tooth surfaces.

When one makes it a habit to use dental floss from his early days, he/she may have healthy tooth and gum in his old age. In this respect, the dentists recommend the teens and students to use dental floss after every meal.

However, with all these effectiveness of the dental floss, the dental floss is not widely used.

The worst drawback of the conventional dental floss is the inconveniences in use, which is the very reason why it is not widely accepted among the public.

The present invention provides a “disposable dental floss-pick implement” in order to overcome all these drawbacks of conventional toothpicks and dental flosses.

For convenience, the term “floss-pick” is used to designate a “disposable tooth pick implement combined with a strand(s) of dental floss” of the present invention throughout the specification.

### DESCRIPTION OF THE PRIOR ARTS

In the prior arts, there have been numerous kinds of dental cleaning implements such as toothbrushes, toothpicks, dental floss, dental floss applicators, and combinations thereof.

However, there has never been a disposable toothpick implement combined with dental floss with which one can carry out picking and flossing operation with ease, convenience and perfection.

### OBJECT OF THE INVENTION

Thus, it is an object of the invention to provide a disposable dental hygiene implement that has all the picking ability of conventional toothpick and the cleaning capability of dental floss.

A further object of the invention is to provide a disposable dental hygiene implement that has the convenience of conventional toothpick to discard after use, and that overcomes the inconveniences in using the conventional dental floss.

Still a further object of the invention is to provide a disposable dental hygiene implement that can be manufactured and sold at a cheap price.

Still a further object of the invention is to provide a disposable dental hygiene implement with which one can make it a habit to use the dental floss from one's early days.

Still a further object of the invention is to provide a disposable dental hygiene implement that overcomes all the disadvantages of conventional toothpicks, dental floss and dental floss applications, and at the same time aims at an efficient cleaning and stimulation without causing damage to the teeth or gum.

### BRIEF DESCRIPTION OF THE DRAWINGS

FIG. 1 is a perspective view of the floss-pick of the invention.

FIG. 2 is a perspective view of a further embodiment of the floss-pick of the invention.

FIG. 3 is an enlarged view of the encircled part A in FIG. 2.

FIG. 4 is a schematic, elevation view of the floss-pick in FIG. 1 held by a user's hand for being used as a tooth pick.

FIG. 5 is a schematic plan view of the floss-pick in FIG. 2 used in a person's teeth.

FIG. 6 is a perspective view of still a further embodiment of the floss-pick of the invention.

FIG. 7 is a schematic, elevation view of the floss-pick in FIG. 6 held by a user's hands for flossing operation.

FIG. 8 is a perspective view of still a further embodiment of the floss-pick of the invention.

FIG. 9 is a schematic plan view of the floss-pick in FIG. 8 used in a person's teeth.

FIG. 10 is an enlarged view of the encircled part B in FIG. 8.

FIG. 11 is a perspective view of still a further embodiment of the floss-pick of the invention.

FIG. 12 is an enlarged view of the encircled part C in FIG. 11.

FIGS. 13 and 14 are perspective views of still further embodiments of the floss-pick of the invention.

FIG. 15 is a schematic plan view of the floss-pick in FIG. 14 used in a person's teeth.

FIGS. 16 through 19 are perspective, partly broken views of still further embodiments of the floss-pick of the invention.

FIG. 20 is a side elevational view of a further embodiment of the floss-pick of the invention.

FIG. 21 is a plan view of the floss-pick in FIG. 20.

FIG. 22 is a perspective view of still a further embodiment of the floss-pick of the invention.

FIG. 23 is a perspective view of a plurality of the floss-pick of the invention in FIG. 14 consecutively and simultaneously formed in the course of manufacture.

### DETAILED DESCRIPTION OF THE PREFERRED EMBODIMENTS

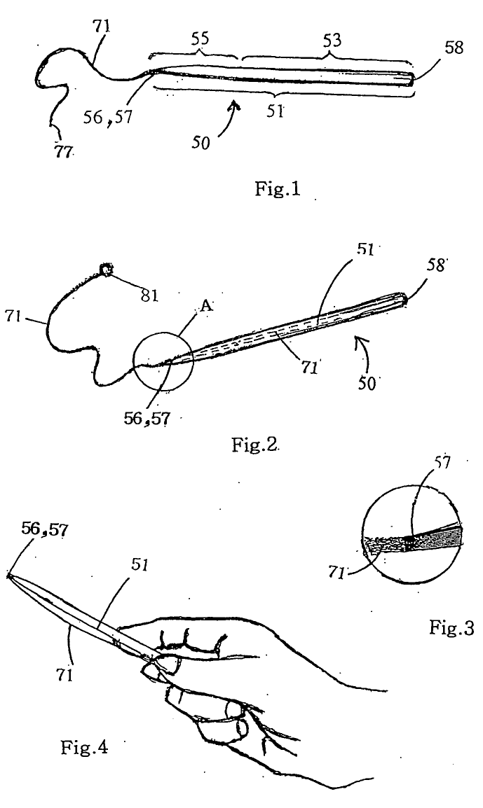

FIG. 1 shows a floss-pick (50) of the present invention in perspective view. It generally comprises an elongated, small pick member (51) having the first marginal end (56) and the second marginal end (58), and at least one strand of floss member (71) is integrally provided to the pick member (51).

The pick member (51) comprises a substantially elongated body portion (53) for being grasped by a user's fingers and a picking portion (55) for being inserted in the gap between the teeth.

The body portion (53) is substantially elongated bar-shaped and has a circular cross section and small diameter, which is similar to that of a conventional toothpick. Further it may also be formed to have irregular overall shape and to be oval, triangular, polygonal or irregular in cross section that is well known in the art.

The body portion (53) of the pick member (51) decreases in size towards an end portion thereof, which is designated herein as the picking portion (55) that can be inserted in the gap between the teeth.

The picking portion (55) is integrally extended from the body portion (53) and gradually reduced in diameter in the direction of any one end portion of the pick member (51) and finally converging to the marginal end (56).

The picking portion (55) may be formed only at one end of the pick member (51) as shown in FIGS. 1, 2 and so on, or at both ends of the pick member (51) as shown in FIG. 13.

Thus, it will be understood that the term “the marginal end (56) (or the marginal end (58)) of the picking portion (55)” designates the same part designated as “the first marginal end (56) (or second marginal end (58))” of the pick member (51).

The picking portion (55) may have a circular, oval, triangular, polygonal cross section and may also be formed to have a small groove along the length thereof.

The pick member (51) is made of known flexible and/or resilient material that is sufficiently soft so as not to damage the teeth or gums and sufficiently sturdy and rigid to remove food debris from between the teeth.

The material may be any one of the wood, paper, rubber, nylon, synthetic material such as plastic or the mixtures thereof.

The floss-pick (50) of the present invention generally comprises an elongated, small pick member (51) and at least one strand of floss member (71) having adequate length that is integrally provided to the pick member (51).

Said strand(s) of floss member (71) is provided along the longitudinal length of the pick member (51) in order to prevent said floss member from being easily separated from the body of said pick member.

The floss member (71) integrally provided to the pick member (51) along the longitudinal length thereof may be either embedded in the body of the pick member (51) by injection molding or adhesively adhered to the surface of the body of the pick member (51) (not shown). Further, the floss member (71) may be spun or wound around the body of the pick member (51).

For examples, in FIGS. 2, 6, 11, 18 and 19, the floss member (71) (dotted line) is integrally embedded in the pick member (51) along the longitudinal length thereof, and in FIG. 13, the floss member (71) is integrally spun on the surface of the body of the pick member (51) along the longitudinal length thereof.

In order to secure solid cohesion adhesive and/or heat may be applied to the floss member (71) and the pick member (51) when the floss member (71) is embedded in, adhered to and/or spun or wound around the body of the pick member (51).

The floss member (71) may be provided to the pick member (51) both along the whole length of the pick member (51) as shown in FIG. 2 as well as at some length of the pick member (51) as shown in FIG. 6.

In the prior arts, there have been disclosed dental floss holders each of which comprises an elongated member one end of which it tapered to a point for picking operation and a suitable length of dental floss provided to said elongated member.

For examples, in the U.S. Pat. No. 407,362 (to Mason Jul. 23, 1889), U.S. Pat. No. 2,648,341 (to Moll Aug. 11, 1953), U.S. Pat. No. 4,576,190 (Youssef Mar. 18, 1986), U.S. Pat. No. 5,253,661 (Alonzo Oct. 19, 1993), there are disclosed toothpicks, dental floss holders and the like that comprise suitable length of dental flosses and elongated members having bores, slits, notched cleats and the like to which said dental flosses are, respectively, inserted and/or attached for flossing operation.

However, in these implements, as one end of the dental floss passes through, is inserted in or attached to said bores, slits and the like by an adhesive, said end of dental floss may easily get separated from said elongated member.

Further, as the free end of the flexible dental floss should be inserted in or attached to said bores or slits of said elongated members and then an adhesive is applied to said elongated member to secure said end of dental floss in said elongated member, said dental floss holder requires both several steps of manual manufacturing as well as higher cost compared to the current automated, computerized mass-production technology,

On the contrary, in the present invention, as the floss member (71) is integrally provided along the longitudinal length of the body of the pick member (51), said floss member can not get easily separated from the body of said pick member and, what is more, the floss-pick (50) can easily be manufactured, at a lower cost, with the current automated, computerized mass-production technology.

The floss member (71) integrally provided to the body of the pick member (51) further extends outwardly from the marginal end(s) of the pick member (51).

In FIGS. 1, 2, and so on, the floss member (71) extends outwardly from the marginal end (56) of the picking portion (55) and in FIG. 11 it extends out from the blunt second marginal end (58) of the pick member (51).

The floss member (71) extends outwardly to have enough length for a user to grasp with the fingers and to carry out the flossing operation.

The length of the extended floss member (71) may preferably range 5 cm-50 cm.

In picking operation, the user may fold the extended portion of the floss member (71) backwardly and grasp the pick member (51) together with the floss member (71) in order to facilitate the picking operation, as shown in FIG. 4.

The folded portion of the floss member (71) placed on the surface of the picking portion (55) is quite efficient in cleaning the surfaces of the teeth as the floss member (71) can adequately conform to the curvature of the teeth and gum when the picking portion (55) reciprocally moves between the teeth.

In flossing operation, the user may grasp the end part (77) of the floss member (71) with one hand and the pick member (51) with the other hand in a similar manner shown in FIG. 7, and then may clean the teeth with the floss member (71).

FIGS. 2, 6, 8 and so on illustrate a further characteristic feature of the present invention.

In the prior arts, there has been numerous types of dental floss (devices) that are provided with beads, grippers and the like that are formed or provided at regular intervals along the length of a strand of dental floss.

For examples, in the U.S. Pat. No. 4,016,892 (to Chodorow Apr. 12, 1977), U.S. Pat. No. 4,807,752 (to Chodorow Feb. 28, 1989), U.S. Pat. No. 4,974,614 (to Selker Dec. 4, 1990), U.S. Pat. No. 6,112,753 (to Arsenault Sep. 5, 2000), there are disclosed dental flosses having bead or tablet-shaped grippers, thickened ends, spherical protuberances and the like formed or provided at regular intervals along the long strand of dental floss for the user to easily grasp the dental floss and to facilitate the manipulation of the dental floss.

These types of dental floss may also be used as the floss material of the floss-pick of the present invention, and the advantages of which are as follows.

In FIG. 2, a bead or tablet-shaped gripping member (81) is provided at the end (77) of the extended floss member (71) for the user to stably and firmly grasp the floss member (71).

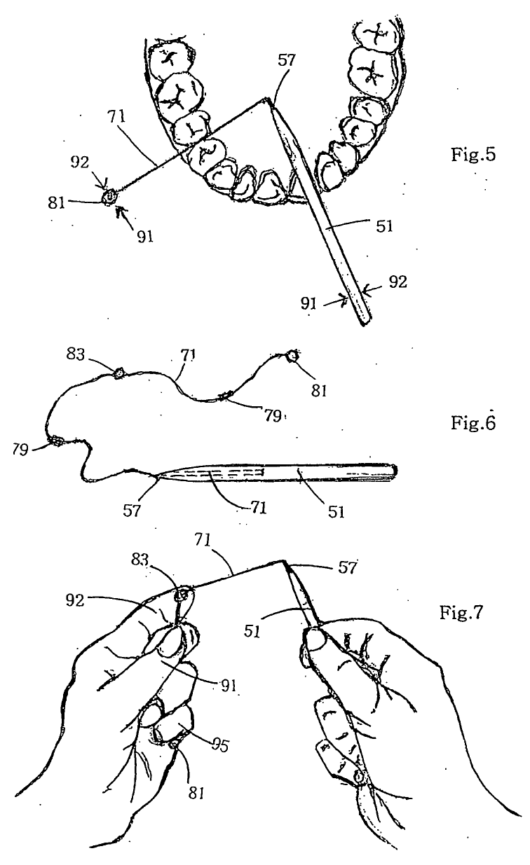

In FIG. 5, the thumb (91) and index finger (92) of one hand grasp the pick member (51) in FIG. 2 and the thumb (91) and the index finger (92) of the other hand grasp the gripping member (81), and the floss member (71) is inserted between the teeth for flossing operation.

Thus, through the reciprocating movements of the hand(s) and marginal end (56) of the pick member (51) the proximal faces of the teeth may be fully treated by the floss member (71) during the cleaning operation.

On the other hand, with the types of dental floss (devices) disclosed in the prior arts, the user should insert the fingers gripping the beads and the like into the mouth.

Further, it is quite inconvenient, if not impossible, to accurately insert the dental floss into the crevices between the molars deep in the mouth.

On the contrary, in the present invention, as the floss member (71) is connected to the long pick member (51), the user, without inserting the fingers into the mouth, can accurately insert the dental floss into the crevices between the molars.

In FIG. 6, in addition to the gripping member (81) provided at the end (77) of the floss member (71), a further gripping member (83) is provided at the middle part of the extended floss member (71) in order to facilitate the grip.

The numeral 79 in FIG. 6 designates protuberances or the like of prior art that is directed to clean food debris lodged between the teeth.

In FIG. 7, the thumb and index finger of the right hand grasp the pick member (51) in FIG. 6, and the gripping member (81) is inserted in or wrapped by the small finger (95) of the left hand and the gripping member (83) is placed on the index finger (92) of the left hand. Thus, the index finger 92 of the left hand can tightly buttress the floss member (71) and the user can efficiently carry out the flossing operation.

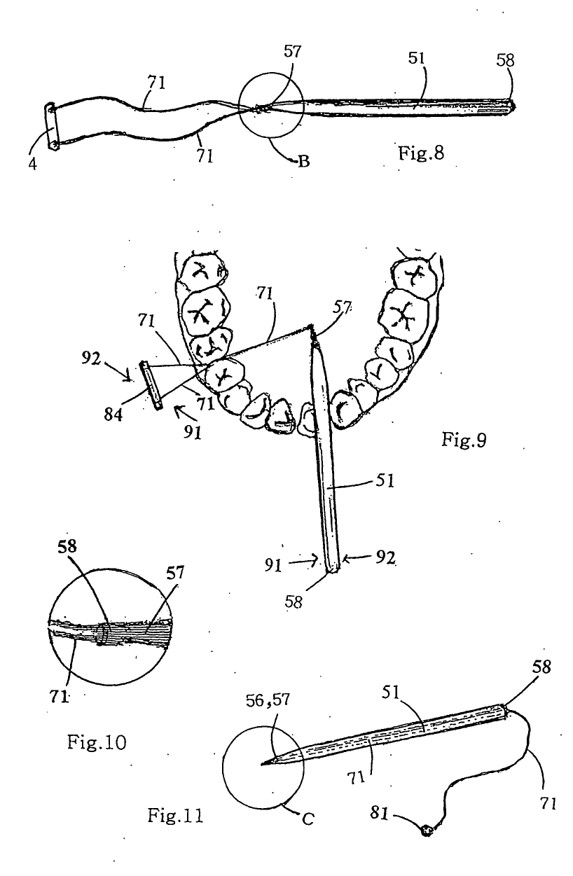

FIGS. 8 and 13 illustrate a further characteristic feature of the floss-pick (50) of the present invention, in which two strands of floss member (71) are extended outwardly from the pick member (51). In FIG. 8, the two floss members (71) are connected to a small bar-shaped gripping member (84), and in FIG. 13 the two floss members (71) are connected to a tablet-shaped gripping member (81).

In FIG. 8, each of the two floss members (71) is connected to the outer ends of a small bar-shaped gripping member (84), respectively. Accordingly, the two strands of floss member (71) are in such a diverged-shape that one can efficiently clean the surfaces of the teeth.

In FIG. 9, the pick member (51) is grasped by the thumb (91) and the index finger (92) of one hand and the gripping member (84) is grasped by the thumb (91) and the index finger (92) of the other hand, and the two strands of the floss members (71) is inserted between the teeth.

Thus, when the user reciprocally moves the hand and the pick member (51) to clean teeth, the diverged floss members (71) contact the surfaces of the teeth more tightly and thereby can clean the surfaces of the teeth with efficiency and perfection.

In case of the two floss members (71) in FIG. 13, the user can insert the index finger in between the floss members (71) and then grasp the gripping member (81) with the thumb and index finger, such that the two strands of the floss member (71) are also in a diverged-shape and one can efficiently clean the surfaces of the teeth.

Preferably the gripping member (81) is a small, flat tablet-like element, bead-shaped element, bar-shaped element, spherical protuberance, or flat piece of paper or plastic, having dimensions suitable to be gripped between two fingers of a user's hand and/or to pass through the crevice between the teeth.

The gripping member (81) may be made of the same material as that of the pick member (51) and/or the floss member (71). The material of the gripping member (81) may be any one of the wood, fiber, paper, rubber, metal, synthetic material such as nylon, plastic or mixtures thereof.

FIGS. 3, 10 and 12 illustrate characteristic feature of the floss-pick (50) of the present invention.

As above described, the picking portion (55) is gradually reduced in diameter and finally converging to the marginal end (56), and at least one strand of floss member (71) is integrally provided along the longitudinal length of the pick member (51) in order to prevent said floss member from being easily separated from the body of said pick member.

At the marginal end (56) the floss member (71) and the material of the pick member (51) are altogether combined with each other, and thereby form a buffering structure of the picking portion (55). The buffering structure is hereinafter designated as the buffering end (57).

At the buffering end (57), as the amount of the material of the pick member (51) is extremely small and the filaments of the floss member (71) is so intermingled with and further closely surrounded by said amount of material, the buffering end (57) is formed to have the softness and the flexibility of the floss member (71) and yet the resilient and rigid characteristics of the material of the picking portion (55).

Further, in order to secure solid cohesion of the material of the picking portion (55) and the floss member (71) at the buffering end (57) very small amount of adhesive and/or the material of the picking portion (55) may further be applied to the marginal end (56).

FIG. 3 is enlarged view of the encircled part A in FIG. 2, in which the floss member (71) extends out from the, buffering end (57).

FIG. 10 is an enlarged view of the encircled part B in FIG. 8, in which the floss member (71) also extends out from the buffering end (57). In FIG. 10, the numeral 58 designates the slightly thickened portion of the buffering end (57) formed of the material of the picking portion (55) and/or the adhesive applied to the marginal end (56).

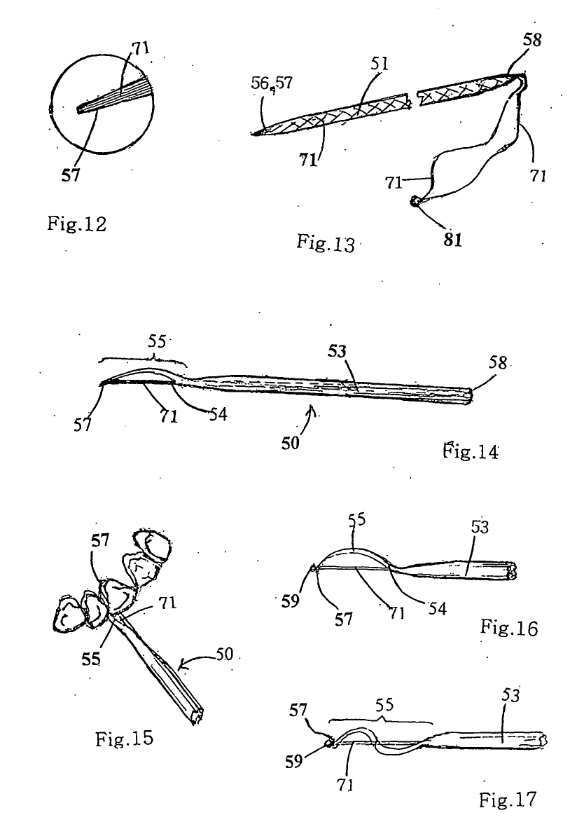

FIG. 12 is an enlarged view of the encircled part C in FIG. 11, in which, the floss member (71) terminates at the buffering end (57).

The floss member (71) shown in FIGS. 3 and 10 may be folded backwardly in the similar manner shown in FIG. 2 for picking operation.

In this case, the buffering end (57) and the part of the extended floss member (71) folded backwardly, next to the buffering end (57), together form above said buffering structure.

The U.S. Pat. No. 1,575,317 (to CARMICHAEL Mar. 2, 1926) and the U.S. Pat. No. 4,462,136 (to Nakao, et al. Jul. 31, 1984) disclose toothpicks that comprise a core or rod-like body of fibrous material and a covering or a shell layer on the outer peripheral section of the fibrous structure.

In these implements, the core or rod-like body of fibrous material near the point is exposed by cutting or grinding and only the tip of said core or rod-like body of fibrous material is used to remove food remnants, dental plaque and massaging gums.

If the tip of said core or rod-like body wear out through repeated use, it may happen that the sharpened rigid covering or shell layer may hurt and damage the teeth and gum tissue.

On the other hand, in the present invention, at the marginal end (56) the filaments of the floss member (71) are intermingled with the material of the pick member (51) and thereby forms the unique buffering end (57) that has the softness and the flexibility of the floss member (71) and yet the resilient and rigid characteristics of the material of the picking portion (55).

Thus, the buffering end (57) cannot hurt nor harm the teeth and gum tissues.

The advantages of the buffering structure of the present invention are as follows.

The advantage of said buffering structure lies in that it overcomes the critical drawback of conventional toothpick, i.e., the sharp and stiff needle pointed end of the conventional toothpick hurts and damages the soft and tender gum tissue.

A further advantage of the buffering structure is that it does the role of a soft brush to remove the food debris between the teeth and plaque on the surface of the teeth and gum margin.

Still a further advantage of the buffering structure is that it absorbs the pushing force applied to the pick member (51) by the user's hand that might, otherwise, damage the surface of the teeth and the gum.

Accordingly, the buffering structure enables one to remove food debris and plaque with safety, sufficiency and satisfaction.

FIG. 14 illustrate a further characteristic feature of the floss-pick (50) of the present invention.

As shown in FIG. 14, the picking portion (55) integrally extended from the body portion (53) and gradually reduced in diameter in the direction of any one end portion of the pick member (51) and finally converging to the marginal end (56) is arcuately curved at the beginning point (54) and forms an elongated arched picking portion (55) providing an elevated midportion and downwardly curving opposite marginal end (56) (buffering end (57)) and the beginning part (54). The beginning point (54) is positioned at the point where the picking portion (55) extends out from the body portion (53).

And at least one strand of floss member (71) having adequate length is secured between marginal end (56) (or buffering end (57)) and the beginning part (54) in a tensioned state.

In picking operation, the buffering end (57) together with the floss member (71) is secured in the crevice between the teeth and dislodges food particles, as shown in FIG. 15.

As the elongated arched picking portion (55) is somewhat resilient and the floss member (71) is slightly tensioned, both the picking portion (55) and the floss member (71) contact the surface of adjacent tooth, respectively.

Under these conditions, if the user rotates pick member (51) and/or moves the pick member (51) back and forth, the tensioned and pressed floss member (71) cleans the surfaces of the teeth completely.

At the marginal end (56), as the floss member (71) and the arched picking portion (55) is intermingled with each other and form the buffering end (57), the distance between the floss member (71) and the arched picking portion (55) is zero.

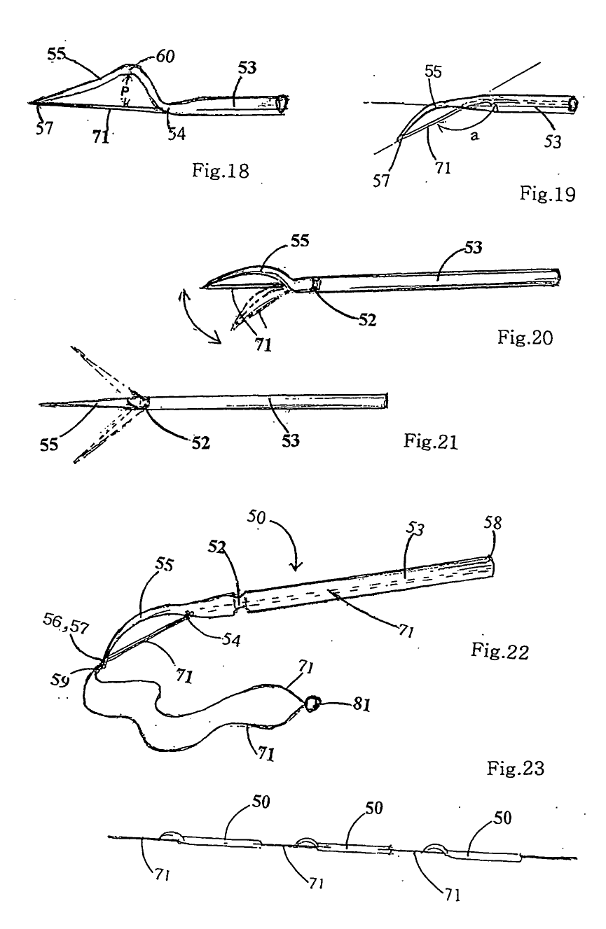

As shown in FIG. 18, the distance P between the floss member (71) and the arched picking portion (55) is gradually increased towards the apex (60) of the picking portion (55), and at the apex (60) of the picking portion (55) said distance becomes the highest, and then again said distance is gradually decreased and the distance becomes zero at the beginning part (54).

Thus, it is preferable that the picking portion (55) is so formed that the apex (60) is positioned at the point that is, from the buffering end (57), two third (2/3) of the distance between the picking portion (55) and the beginning part (54).

The greatest distance P between the floss member (71) and the arched picking portion (55) may preferably be slightly greater than the height of a tooth from the crown to the adjacent gum area when the pick member (51) is rotated and the floss member (71) slides out from between the teeth with the picking portion (55) being disposed at or below the adjacent gum tissue.

When the floss member (71) slides out from between the teeth and the picking portion (55) is disposed between the teeth, the user may draw picking portion (55) out from between the teeth letting the floss member (71) again pass through the teeth and finally being drawn out together with the picking portion (55).

The distance P may range 0.1 cm-2 cm.

In FIGS. 16 through 18, the floss member (71) is secured between the marginal end (56) (or buffering end (57)) and the beginning part (54) and connected thereto respectively.

However, as above described, the floss member (71) is integrally provided to the pick member (51) along the longitudinal length thereof and may be either embedded in, adhered to, or spun or wound around the body of the pick member (51).

Thus, when the floss member (71) is integrally provided to the pick member (51) along the longitudinal length thereof, the floss member (71) is exposed at the beginning part (54) and directly connected to the marginal end (56) of the arched picking portion (55) as shown in FIGS. 14, 19 and 22.

The numeral 59 in FIGS. 16 and 17 designates knot or small bead formed to prevent the slippage of the floss member (71) from the buffering end (57).

The floss member (71) and the picking portion (55) heretofore described in connection with the FIGS. 1 through 14 are almost in parallel relationship with the body portion (53).

However, as shown in FIG. 19, the picking portion (55) may curved a little downwardly that creates an angle “a” between floss member (71) and axis of the body portion (53) for easier insertion of the picking portion (55) into the crevice between the molars.

FIG. 20 is a side elevational view of a further embodiment of the floss-pick of the invention.

In FIG. 20, a reduced portion (52) in diameter is provided near the picking portion (55) for the user to vertically bend the picking portion (55) for easier manipulation of the floss-pick (50).

FIG. 21 is a plan view of the floss-pick in FIG. 20. As shown in FIG. 21, a user can horizontally bend the picking portion (55) for easier manipulation of the floss-pick (50).

A small metal wire or plate may be embedded in the pick member (51) of the present invention to secure easier bending and durability of the picking portion (55).

FIG. 22 is a perspective view of still a further embodiment of the floss-pick of the invention.

FIG. 23 is a perspective view of a plurality of the floss-pick of the invention in FIG. 14 consecutively and simultaneously formed by injection molding.

The pick member (51) and gripping member (81) may be injection molded directly around or onto the floss.

### ADVANTAGES OF THE INVENTION

The heretofore explained “buffering structure of the pick member (51) and/or the floss member (71) having the gripping member (81) connected thereto” is quite efficient in removing the food debris and plaque from the teeth and gum margin, which is impossible to attain with conventional toothpick and dental floss.

The floss-pick (50) of the present invention, first of all, overcomes the worst drawback of conventional toothpick that the sharp, needle pointed end of the toothpick penetrates, hurts and/or damages the soft gum tissue.

What is better, the buffering structure of the pick member (51) of the present invention is quite appropriate for cleaning around the surfaces and gingival margins of the teeth, which is almost impossible to attain with the sharp, needle pointed end of conventional toothpick.

Further, the floss-pick (50) of the invention can be manufactured and sold at almost the same cost as that of conventional disposable toothpicks.

What is more, the floss-pick (50) of the invent ion enables one to use the dental floss as conveniently as the disposable toothpicks, which is quite impossible to attain with conventional dental floss products.

The greatest merit of the invention lies in that as the dental floss is automatically provided together with a disposable toothpick as a part thereof the convenience will make the teens and students to habitually use dental floss after every meal.

It will be recognized by persons skilled in the art that numerous variations and modifications may be made to the invention as described above without departing from the spirit or scope of the invention as broadly described.

What is claimed is:

1. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said strand of floss member (71) having adequate length being integrally provided to the pick member (51) along the longitudinal length thereof,
said floss member (71) integrally provided to the body of the pick member (51) further extending outwardly from the marginal end of the pick member (51) opposite to the marginal end (56) of the picking portion (55), and
said floss member (71) extending outwardly to have enough length for a user to grasp with the fingers and to carry out the flossing operation.

2. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said strand of floss member (71) having adequate length being integrally provided to the pick member (51) along the longitudinal length thereof,
said floss member (71) integrally provided to the body of the pick member (51) further extending outwardly from the marginal end of the pick member (51) opposite to the marginal end (56) of the picking portion (55),
said floss member (71) extending outwardly to have enough length for a user to grasp with the fingers and to carry out the flossing operation, and
at the marginal end (56) the filaments of the floss member (71) and the material of the pick member (51) being altogether combined with each other, and thereby forming a buffering structure of the picking portion (55).

3. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said strand of floss member (71) having adequate length being integrally provided to the pick member (51) along the longitudinal length thereof,
said floss member (71) integrally provided to the body of the pick member (51) further extending outwardly from the marginal end (56) of the picking portion (55),
said floss member (71) extending outwardly to have enough length for a user to grasp with the fingers and to carry out the flossing operation, and
at the marginal end (56) the filaments of the floss member (71) and the material of the pick member (51) being altogether combined with each other, and thereby forming a buffering structure of the picking portion (55).

4. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said picking portion (55) being arcuately curved at the beginning point (54) that is positioned at the point where the picking portion (55) extends out from the body portion (53) and forms an elongated arched picking portion (55) providing an elevated midportion and downwardly curving opposite marginal end (56) (buffering end (57)) and the beginning part (54), and
at least one strand of floss member (71) having adequate length being secured between marginal end (56) (or buffering end (57)) and the beginning part (54) in a tensioned state.

5. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said picking portion (55) being arcuately curved at the beginning point (54) that is positioned at the point where the picking portion (55) extends out from the body portion (53) and forms an elongated arched picking portion (55) providing an elevated midportion and downwardly curving opposite marginal end (56) (buffering end (57)) and the beginning part (54),
at least one strand of floss member (71) having adequate length being secured between marginal end (56) (or buffering end (57)) and the beginning part (54) in a tensioned state, and
at the marginal end (56) the filaments of the floss member (71) and the material of the pick member (51) being altogether combined with each other, and thereby forming a buffering structure of the picking portion (55).

6. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said strand of floss member (71) having adequate length being integrally provided to the pick member (51) along the longitudinal length thereof,
one end of said floss member (71) integrally provided to the body of the pick member (51) further extending outwardly from the marginal end of the pick member (51) opposite to the marginal end (56) of the picking portion (55),
said floss member (71) extending outwardly to have enough length for a user to grasp with the fingers and to carry out the flossing operation,
said picking portion (55) being arcuately curved at the beginning point (54) that is positioned at the point where the picking portion (55) extends out from the body portion (53) and forms an elongated arched picking portion (55) providing an elevated midportion and downwardly curving opposite marginal end (56) (buffering end (57)) and the beginning part (54), and
the other end of said strand of floss member (71) being secured between marginal end (56) (or buffering end (57)) and the beginning part (54) in a tensioned state.

7. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
said strand of floss member (71) having adequate length being integrally provided to the pick member (51) along the longitudinal length thereof,
one end of said floss member (71) integrally provided to the body of the pick member (51) further extending outwardly from the marginal end of the pick member (51) opposite to the marginal end (56) of the picking portion (55),
said floss member (71) extending outwardly to have enough length for a user to grasp with the fingers and to carry out the flossing operation,
said picking portion (55) being arcuately curved at the beginning point (54) that is positioned at the point where the picking portion (55) extends out from the body portion (53) and forms an elongated arched picking portion (55) providing an elevated midportion and downwardly curving opposite marginal end (56) (buffering end (57)) and the beginning part (54),
the other end of said strand of floss member (71) being secured between marginal end (56) (or buffering end (57)) and the beginning part (54) in a tensioned state, and
at the marginal end (56) the filaments of the floss member (71) and the material of the pick member (51) being altogether combined with each other, and thereby forming a buffering structure of the picking portion (55).

8. A disposable dental hygiene implement comprising:
a tooth pick member (51) having an elongated length and small diameter and at least one strand of floss member (71) provided thereto;
said pick member (51) comprising a substantially elongated body portion (53) for being grasped by a user's fingers and a picking portion (55) for being inserted in the gap between the teeth,
said picking portion (55) being integrally extended from the body portion (53) and gradually reduced in diameter in the direction of a marginal end (56) of the pick member (51) and finally converging to the marginal end (56),
one end of said strand of floss member (71) having adequate length being integrally provided to the pick member (51) along the longitudinal length thereof,
said picking portion (55) being arcuately curved at the beginning point (54) that is positioned at the point where the picking portion (55) extends out from the body portion (53) and forms an elongated arched picking portion (55) providing an elevated midportion and downwardly curving opposite marginal end (56) (buffering end (57)) and the beginning part (54),
the other end of said strand of floss member (71) being secured between marginal end (56) (or buffering end (57)) and the beginning part (54) in a tensioned state,
at the marginal end (56) the filaments of the floss member (71) and the material of the pick member (51) being altogether combined with each other, and thereby forming a buffering structure of the picking portion (55).
the other end of said floss member (71) secured to the marginal end (56) further extending outwardly from the marginal end (56) of the picking portion (55), and
said floss member (71) extending outwardly to have enough length for a user to grasp with the fingers and to carry out the flossing operation.

9. The disposable dental hygiene implement according to claim 1, 2, 3, 6, 7, or 8, wherein, said floss member (71) is comprised of one strand of dental floss and provided with a bead or tablet-shaped gripping member (81) for the user to stably and firmly grasp the floss member (71).

10. The disposable dental hygiene implement according to claim 1, 2, 3, 6, 7, or 8, wherein, said floss member (71) is comprised of two strands of dental floss and said two strands of
said floss member are connected to a bead or tablet-shaped gripping member (81) for the user to stably and firmly grasp the floss member (71).

11. The disposable dental hygiene implement according to claim 1, 2, 3, 6, 7, or 8, wherein, said floss member (71) integrally provided to the pick member (51) along the longitudinal length thereof is embedded in, adhered to, or spun or wound around the body of the pick member (51).
